(19) United States
(12) Patent Application Publication
(10) Pub. No.: US 2016/0007101 A1
(43) Pub. Date: Jan. 7, 2016

(54) Sensor Device

(71) Applicant: Infineon Technologies AG, Neubiberg (DE)

(72) Inventors: Dietmar Straeussnigg, Villach (AT); Andreas Wiesbauer, Poertschach (AT); Christian Jenkner, Klagenfurt (AT)

(21) Appl. No.: 14/321,475

(22) Filed: Jul. 1, 2014

(51) Int. Cl. H04Q 9/14

(52) U.S. Cl. CPC H04Q 9/14

(57) ABSTRACT

A sensor and a method for sensing a signal are disclosed. In one embodiment, a sensor device includes a first sensor circuitry configured to provide a first sensor signal in a first frequency band, a second sensor circuitry configured to provide at least one second sensor signal in a second frequency band and a combiner circuitry configured to combine the first and the at least one second sensor signal into a combined sensor signal.

### TECHNICAL FIELD

Embodiments of the present disclosure generally relate to sensor devices comprising a plurality of different sensors and, more particularly, to concepts for reducing the electrical wiring effort coming with such multiple sensors.

### BACKGROUND

Driven by latest market requirements multiple sensors of different types are increasingly required for mobile applications, such as smartphones, tablet computers, or laptop computers. Commonly used sensor types are acoustic sensors, for example, in the form of microphones. In addition, there is a desire to include other types of sensors in mobile applications for sensing physical quantities of interest of a surrounding area, such as (barometric) pressure sensors, temperature sensors, or humidity sensors—just to name a few examples. Conventionally, different types of sensors are installed independently in the applications. This often results in overhead with respect to electrical wiring.

Therefore, there is a desire for a reduction in the number of interconnections and thus the electrical wiring effort.

### SUMMARY

According to one aspect of the present disclosure, it is provided a sensor device. The sensor device includes first sensor circuitry configured to provide a first sensor signal in a first frequency band. Further, the sensor device includes second sensor circuitry configured to provide at least one second sensor signal in a second frequency band. Also, the sensor device includes combiner circuitry configured to combine the first and the at least one second sensor signal into a combined sensor signal. Hence, the sensor device may include multiple sensors and/or related electrical analog and/or digital circuitry. The signals coming from the different sensors may be combined or multiplexed to one combined sensor signal.

In one or more embodiments, the sensor device may further comprise an interface configured to output the combined sensor signal via a single electrical output line.

In some embodiments, the combiner circuitry may be configured to provide the combined sensor signal as a binary signal.

In some embodiments, the combiner circuitry may comprise a pulse density modulator configured to convert an analog or n-ary digital combined sensor signal, with n>2, to a binary combined sensor signal.

In one or more embodiments, the first and the second sensor circuitry may include sensors of different types. For example, the first sensor circuitry may be configured to measure a first physical quantity causing signal variations in the first frequency band above a frequency threshold. The second sensor circuitry may be configured to measure a second physical quantity causing signal variations in the second frequency band below said frequency threshold.

In some embodiments, the first sensor circuitry may comprise an acoustic sensor, such as a microphone. In one embodiment, the microphone may be a MEMS microphone. The microphone may be coupled to a Sigma-Delta Analog-to-Digital Converter (SDADC) to provide a digital first sensor signal. In one embodiment, an output of the SDADC may be coupled to a digital high-pass filter for noise reduction.

In some embodiments, the second sensor circuitry may comprise at least one of a pressure sensor, a temperature sensor, or a humidity sensor. Other sensor types which measure signals outside the audible acoustic frequency band, e.g., below 20 Hz or above 20 kHz, are also possible.

In some embodiments, the sensor device may further comprise sampling rate conversion circuitry configured to adapt a sampling rate of the second sensor signal to a sampling rate of the first sensor signal, or vice versa.

In some embodiments, the sensor device may further comprise circuitry to shift the first and/or the at least one second sensor signal to first and second non-overlapping frequency bands.

In one embodiment, the first and the second sensor circuitry may be arranged within a common semiconductor package. In another embodiment, the first and the second sensor circuitry may be formed on a common semiconductor die.

Some embodiments include a mobile device, e.g., a smartphone, comprising the sensor device.

According to a further aspect of the present disclosure it is provided a receiver device, the receiver device including receiver circuitry configured to receive a combined sensor signal comprising a first sensor signal in a first frequency band and at least a second sensor signal in a second frequency band, and separation circuitry configured to separate the combined sensor signal into the first and the second sensor signal.

In some embodiments, the separation circuitry may comprise a high-pass and/or a low pass filter to separate the first and the second sensor signal.

According to a yet further aspect of the present disclosure, it is provided a method, the method comprising an act of providing a first sensor signal in a first frequency band, an act of providing at least a second sensor signal in a second frequency band, and an act of combining the first and the at least one second sensor signal into a combined sensor signal.

In one or more embodiments, the method may further comprise transmitting the combined sensor signal via a single signal line. In one embodiment, the combined sensor signal may be transmitted over said signal line as a binary signal.

In some embodiments, the first and the second sensor signals are provided in first and second non-overlapping frequency bands.

In some embodiments, the first frequency band may comprise a useful signal having frequency components higher than 20 Hz. The second frequency band may comprise a useful signal having frequency components lower than 20 Hz.

In some embodiments, the first sensor signal may be an acoustic sensor signal. The second sensor signal may be a pressure or temperature sensor signal.

Some embodiments comprise digital circuitry installed within the devices or apparatuses for performing the respective acts. Such a digital control circuitry, e.g., a Digital Signal Processor (DSP), a Field-Programmable Gate Array (FPGA), an Application-Specific Integrated Circuit (ASIC), or a general purpose processor may be coupled to memory circuitry and needs to be configured accordingly by hardware and/or software. Hence, yet further embodiments also provide a computer program having a program code for performing embodiments of the method(s), when the computer program is executed on a computer or a programmable hardware device.

### BRIEF DESCRIPTION OF THE DRAWINGS

Some embodiments of apparatuses and/or methods will be described in the following by way of example only, and with reference to the accompanying figures, in which

FIG. 1 illustrates a schematic block diagram of a sensor device according to an embodiment;

FIG. 2 illustrates a block diagram of a system including sensor device and a receiving device, according to an embodiment;

FIG. 3 illustrates a block diagram of a system including sensor device and a receiving device, according to a further embodiment;

FIG. 4 illustrates a block diagram of a system including sensor device and a receiving device, according to yet a further embodiment; and

FIG. 5 illustrates a schematic flow of a method according to an embodiment.

### DETAILED DESCRIPTION OF ILLUSTRATIVE EMBODIMENTS

Various example embodiments will now be described more fully with reference to the accompanying drawings in which some example embodiments are illustrated.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures. It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or group thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of example embodiments and corresponding detailed description are presented in terms of software, or algorithms and symbolic representations of operation of data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware at existing network elements or control nodes. Such existing hardware may include one or more Central Processing Units (CPUs), Digital Signal Processors (DSPs), Application-Specific Integrated Circuits, Field Programmable Gate Arrays (FPGAs), computers, or the like.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

As disclosed herein, the term “storage medium”, “storage unit” or “computer readable storage medium” may represent one or more devices for storing data, including Read Only Memory (ROM), Random Access Memory (RAM), magnetic RAM, core memory, magnetic disk storage mediums, optical storage mediums, flash memory devices and/or other tangible machine readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, a processor or processors will perform the necessary tasks.

A code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable means including memory sharing, message passing, token passing, network transmission, etc.

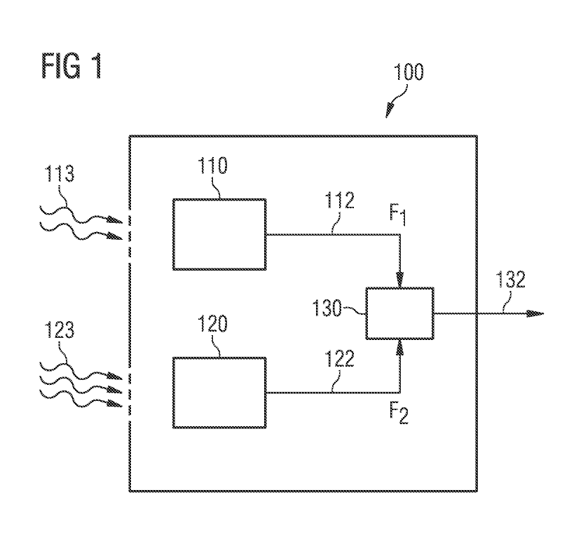

FIG. 1 illustrates a schematic block diagram of a sensor device 100 according to an example embodiment.

The sensor device 100 comprises first sensor circuitry 110 which is configured to provide or generate a first sensor signal 112 in a first frequency band F₁. The device 100 further comprises second sensor circuitry 120 which is configured to provide or generate at least one second sensor signal 122 in a second frequency band F₂. Further included is combiner circuitry 130 configured to combine the first sensor signal 112 and the at least one second sensor signal 122 into a combined sensor signal 132. The combined sensor signal 132 may also be considered as a multiplexed sensor signal, in particular a frequency division multiplexed sensor signal.

The first sensor circuitry 110 and the second sensor circuitry 120 of the sensor device 100 may include different sensors of different types. That is to say, the first sensor circuitry 110 may include a first sensor configured to measure or sense a first physical quantity 113. The second sensor circuitry 120 may include a second sensor of different type configured to measure or sense a second physical quantity 123.

In some embodiments, the first physical quantity 113 may cause signal variations of the first sensor signal 112 (or a useful part thereof) above a certain frequency threshold. Further, the measured signal variations in the first sensor signal 112 may cover the first frequency band F₁. The second physical quantity 123 may cause signal variations of the second sensor signal 122 (or a useful part thereof) below said frequency threshold. The measured signal variations in the second sensor signal 122 may cover the second frequency band F₂. That is to say, the first and the second sensor signals 112, 122 (or the useful parts thereof) may cover first and second non-overlapping frequency bands F₁, F₂, according to some embodiments. The latter may be the case for example, if the frequency components of the first sensor signal 112 are higher than the frequency components of the second sensor signal 122.

Substantially non-overlapping sensor signal frequency bands F₁, F₂ may be obtained, for example, if the first sensor circuitry 110 and the second sensor circuitry 120 measure different physical quantities 113, 123 causing signal variations in non-overlapping frequency bands, respectively. In some embodiments, the first sensor circuitry 110 may be configured to measure a physical quantity 113 which is more variable or fluctuating than the second physical quantity measured by the second sensor circuitry 120. For example, in some embodiments, the first sensor circuitry 110 may comprise an acoustic sensor, such as a microphone. Typically, the acoustic frequency band audible for humans lies in the range of approximately 20 Hz to 20 kHz. The second sensor circuitry 120 may comprise at least one of a pressure sensor, a temperature sensor, or a humidity sensor, for example. Other sensor types for comparatively slowly varying physical quantities are also possible. The latter sensors will output the second sensor signal 122 having useful signal components below the audible frequency spectrum, i.e., the second frequency band will be below 20 Hz for such environmental sensor types.

In one embodiment, the sensor device 100 may be included in a semiconductor package, for example. That is to say, the first and the second sensor circuitry 110, 120 may be arranged within a common semiconductor package. In such embodiments, the first and the second sensor circuitry 110, 120 may be implemented as first and second sensor semiconductor chips. The combiner circuitry 130 may either be included in one of the sensor semiconductor chips or may be implemented as a separate semiconductor device of the semiconductor package. In other embodiments, the first and the second sensor circuitry 110, 120 and optionally the combiner circuitry 130 may be integrated on a common semiconductor die. For example, the sensor device 100 may be implemented as a single semiconductor chip including the first and the second sensor circuitry 110, 120 and optionally also the combiner circuitry 130.

Such a semiconductor package or chip including multiple sensor circuitries 110, 120 may be used for numerous applications, including applications for wireless mobile devices, such as smartphones, tablet computers, laptop computers, etc. For applications in small and lightweight mobile device platforms it may be of particular interest to save interfaces and wiring among various components. Therefore, in some embodiments, the sensor device 100 may comprise an output interface which is configured to output the combined sensor signal 132 via a single output line to a receiving component, for example of a mobile device platform. Hence, the single output line may be used to convey both the first sensor signal 112 and the at least one second sensor signal 122 to a receiving component in different frequency bands at the same time.

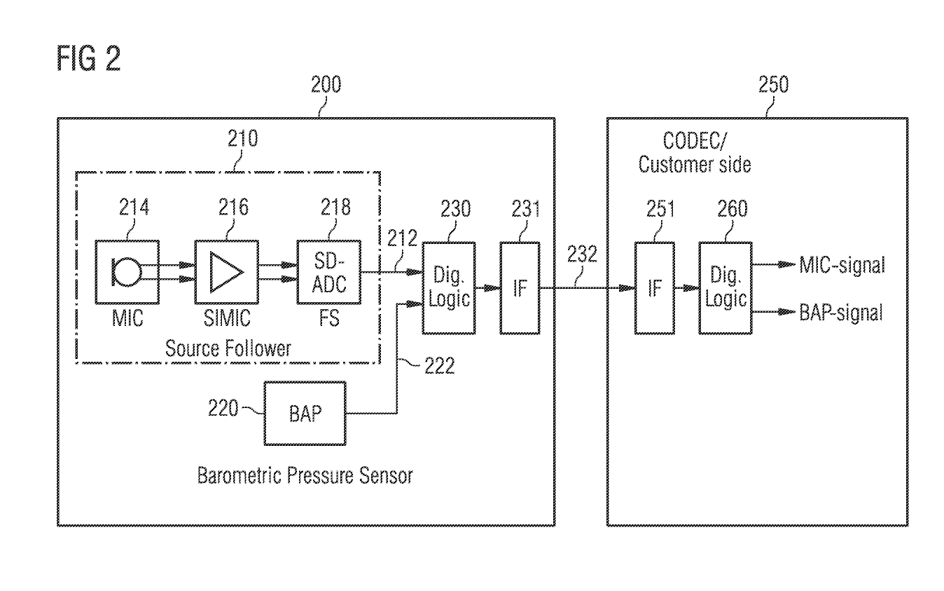

Turning now to FIG. 2, it is illustrated an example combination of a microphone sensor signal 212 and a barometric pressure sensor signal 222, as well as a signal transmission of the combined signal 232 via a connecting line. FIG. 2 shows a device 200 for transmitting the combined sensor signal 232 via a single line to a receiving device 250. For example, both devices 200 and 250 may be installed within a mobile device, such a smartphone or the like.

According to the embodiment of FIG. 2, first sensor circuitry 210 of the sensor device 200 includes a (stereo) microphone 214 coupled to an amplifier 216 which again is coupled to an Analog-to-Digital Converter (ADC) 218. In the illustrated example implementation, the ADC 218 is a Sigma-Delta Analog-to-Digital Converter (SDADC) to provide a digital first sensor signal 212. The SDADC 218, also referred to as a 1-bit converter, is based on delta-sigma modulation. An advantage of SDADC is that the dynamics can be mutually exchanged by the bandwidth within certain limits. Due to the continuous sampling at the input, no sample and hold circuit is required. Also, there are low demands for an anti-aliasing filter. Note however, that also other ADC concepts may be used.

The microphone 214, the amplifier 216, and the ADC 218 may be implemented on a common semiconductor die forming a so-called digital Silicon Microphone (SIMIC). Silicon microphones may also be referred to as MEMS (MicroElectrical-Mechanical System) microphones or microphone chips. A pressure-sensitive diaphragm is etched directly into a silicon chip by MEMS techniques, and is usually accompanied with integrated preamplifier circuitry 216. Most MEMS microphones are variants of the condenser microphone design. Often MEMS microphones have built in ADC circuits 218 on the same Complementary Metal-Oxide-Semiconductor (CMOS) chip making the chip a digital microphone and so more readily integrated with other digital products.

Second example sensor circuitry 220 of the sensor device 200 includes a Barometric Pressure Sensor (BAP) that delivers a digital barometric pressure signal 222 at its output. Note again, that other environmental sensor types would be possible as well.

The digital microphone signal 212 and the digital pressure signal 222 are both fed to a digital combiner logic 230 which is configured to output a digital combined signal 232 including both the digital microphone signal 212 and the digital pressure signal 222. The combined signal 232 is transmitted from the sensor device 200 to the receiver device 250 via an interface 231 using only a single transmission line, thereby saving interconnections.

The receiver device 250 may be also referred to as CODEC (from Coder-Decoder). Thereby a CODEC commonly denotes a hardware device or computer program capable of encoding or decoding a digital data stream or signal. The receiver device 250 comprises receiver circuitry or an interface 251 which is configured to receive the combined sensor signal 232 via the single transmission line. Separation circuitry 260 of the device 250 is used to separate or split the combined sensor signal 232 into its signal components, e.g., the microphone signal 212 and the pressure signal 222.

To summarize the functionality of the example system according to FIG. 2, the two useful signals 212 and 222 (MIC signal and BAP signal) are combined in order to reduce the number of interconnections and thus the amount of wiring between the devices 200 and 250. The two sensor signals 212, 222 are combined into one signal 232 which is then transmitted via a communication line. On the CODEC side, the received combined signal is separated again into the two useful signals 212, 222.

When combining the sensor signals 212, 222 the fact is exploited that the MIC signal 212 and the BAP signal 222 use different frequency bands. The MIC signal 212 uses the range from about 20 Hz to a maximum of 20 kHz. The BAP signal 222 uses the range below 20 Hz (mode-dependent). In general, the low-frequency BAP signal 222 could also be transformed to another free frequency range e.g. by means of modulation and could then be combined with the MIC signal 212. Hence, in some embodiments, the device 200 could also comprise circuitry to transform or shift the first and/or the at least one second sensor signal 212, 222 to first and second non-overlapping frequency bands, similar to the concept of Frequency Division Multiplexing (FDM).

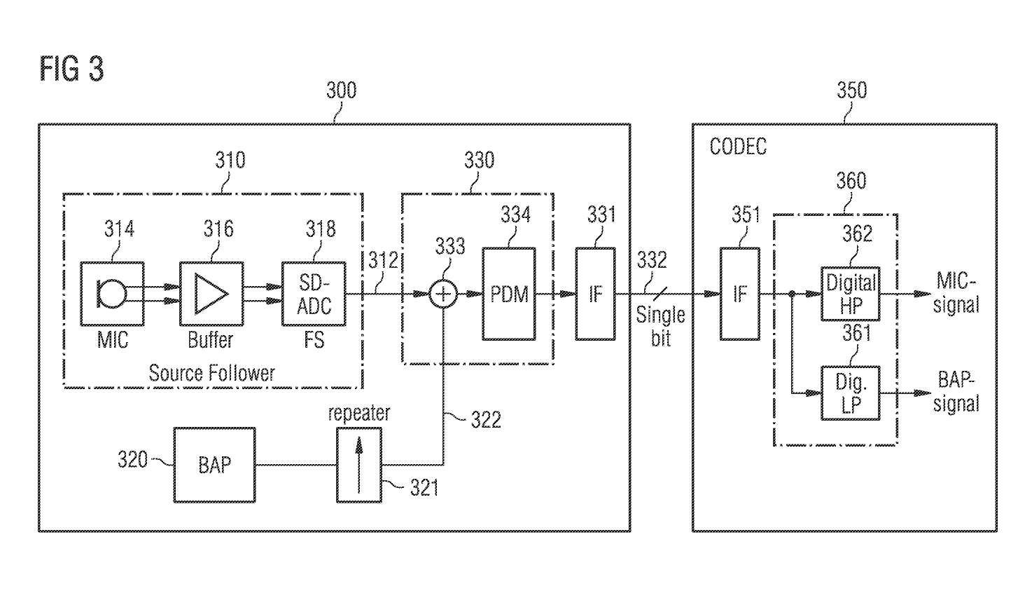

FIG. 3 shows a block diagram of a further embodiment.

The first sensor circuitry 310 of sensor device 300 does not differ from the sensor circuitry 210 explained with reference to FIG. 2. FIG. 3 shows a more detailed embodiment of the sensor signal combination. Here, the digital MIC signal 312 and the digital BAP-signal 322 are generated from their respective sensors 314, 320 with different sampling rates. Therefore, the output of the BAP sensor 320 is coupled to sampling rate conversion circuitry 321, which may also be referred to as repeater or up-sampler. The latter may be used to adapt a sampling rate of the digital BAP-signal 322 to a sampling rate of the digital MIC signal 312, or vice versa. In particular, the sampling rate conversion circuitry 321 may interpolate (or up-sample) the digital BAP signal 322 to the higher sampling frequency of the digital MIC signal 312. Then, the rate-adapted signals 312 and 322 may be combined by means of a digital combiner 333.

In the example implementation of FIG. 3, the digital combiner circuitry 330 is configured to provide the digital combined sensor signal as a binary signal. For that purpose, the combiner circuitry 330 of FIG. 3 further includes a Pulse Density Modulator (PDM) 334 downstream to an adder or combiner 333. The PDM 234 does not encode specific amplitude values of the combined sensor signal into pulses of different size. Instead, it is the relative density of the pulses that corresponds to the combined sensor signal's amplitude. The PDM 334 is hence configured to convert an analog or an n-ary (n>2) digital combined sensor signal to a binary (n=2) combined sensor signal 332. That is to say, the output of the PDM 334 is a binary signal (1-bit signal). Pulse-Width Modulation (PWM) is a special case of PDM where all the pulses corresponding to one sample are contiguous in the digital signal.

The combined 1-bit sensor signal 332 is transmitted via a single transmission line between the interfaces 331, 351 to the codec 350 (on the customer side). There, the two sensor signals 312 and 322 may be extracted from the received combined sensor signal using a digital high-pass for the MIC signal 312 and/or low-pass filter for the BAP signal 322.

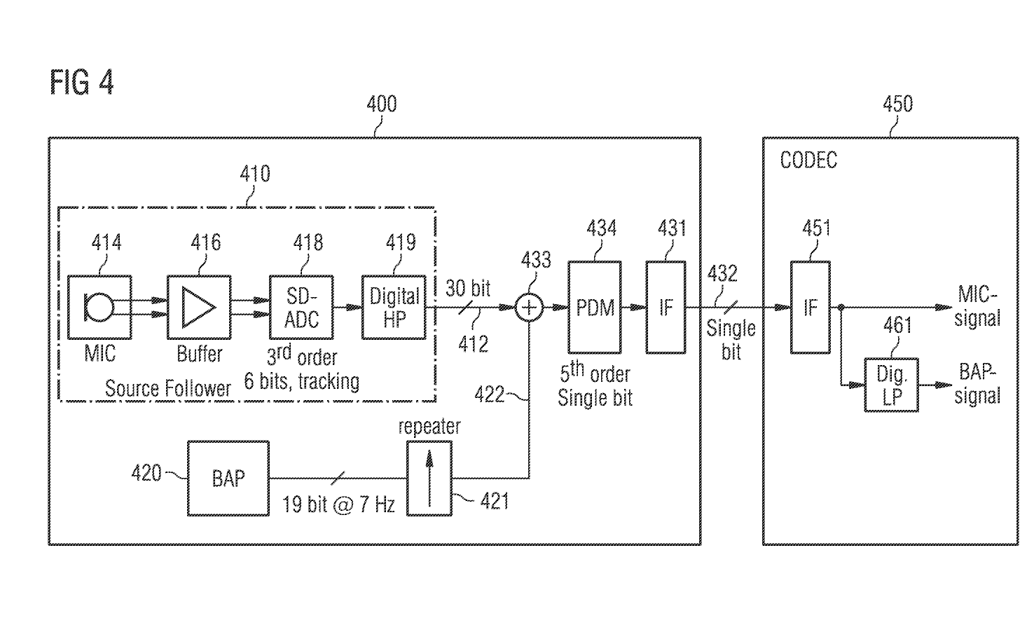

In order to keep the adjustments on the receiver or CODEC side as low as possible, a further example embodiment is presented in FIG. 4.

Here, first sensor circuitry 410 of sensor device 400 has been supplemented by a digital high-pass filter 419 coupled to the digital output of the SDADC 418. An output of the digital high-pass filter 419 is coupled to an input of the digital adder or combiner 433. With the high-pass filter 419 at the output of the SDADC 418 low-frequency noise signal components of the digital MIC signal 412 may be reduced. Further, no high-pass filter is required on the receiver or CODEC device 450, thus keeping the receiving end simple.

Again, the digital MIC signal 412 and the digital BAP-signal 422 are generated from their respective sensors 414 and 420 with different sampling rates. Therefore, the output of the BAP sensor 420 is coupled to sampling rate conversion circuitry 421. The up-sampled digital BAP-signal 422 is fed to a second input of the digital combiner 433 and combined with the digital MIC signal 412.

The application of the high-pass filter 419 on the MIC signal 412 allows the BAP signal 422 to be scaled down (to lower levels) relative to the MIC signal 412 since the resolution is limited in this frequency range only by the quantization noise of the PDM 434 (in this low frequency range a high resolution is guaranteed by a high oversampling). Filtering with the high pass 419 and scaling the BAP signal 422 to lower levels allows reducing the required dynamic range (and thus the risk of over-steering) and avoiding the digital high-pass filter at the CODEC side (or at least reducing its order)

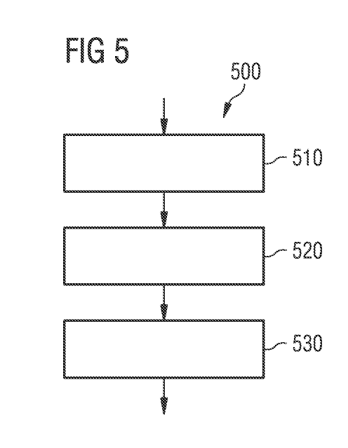

Turning now to FIG. 5, a schematic flowchart of a method 500 according to an example embodiment is shown.

Method 500 includes an act 510 of providing a first sensor signal in a first frequency band F₁. In a further act 520 at least one second sensor signal is provided in a second frequency band F₂. The first and the at least one second sensor signal are combined into a combined sensor signal in act 530 of method.

Optionally, the combined sensor signal, which may be generated as a binary signal, may be transmitted to a receiver device via a single signal line.

As has been explained before, the first and/or second frequency bands F₁, F₂ may be inherent to measurements of respective physical quantities 113, 123. That is to say, variations of the respective physical quantities associated with the first and/or second sensor signals may cause the first and/or second frequency bands F₁, F₂. In other words, when combining the sensor signals the fact may be exploited that the first sensor signal and the second sensor signal inherently use different frequency bands. For example, this may be the case when the first sensor signal is an acoustic sensor signal and when the second sensor signal is a pressure or temperature sensor signal.

In some embodiments, however, the first and/or the second sensor signal may alternatively or additionally be frequency shifted to certain frequency ranges, respectively, similar to Frequency-Division Multiplexing (FDM), thus causing non-overlapping first and second frequency bands F₁, F₂.

In the foregoing some example topologies/architectures relating to a combination of a pressure sensor and a microphone for transmission of the combined sensor signal over a single interface/line have been presented. Embodiments may be particular useful for the circuit design or layout of mobile devices, such as smartphones, laptops or the like.

The description and drawings merely illustrate the principles of the invention. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

Functional blocks shall be understood as functional blocks comprising circuitry that is adapted for performing a certain function, respectively. Hence, a “module or entity for s.th.” may as well be understood as a “module or entity being adapted or suited for s.th.”. A module or entity being adapted for performing a certain function does, hence, not imply that such means necessarily is performing said function (at a given time instant).

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

Furthermore, the following claims are hereby incorporated into the Detailed Description, where each claim may stand on its own as a separate embodiment. While each claim may stand on its own as a separate embodiment, it is to be noted that—although a dependent claim may refer in the claims to a specific combination with one or more other claims—other embodiments may also include a combination of the dependent claim with the subject matter of each other dependent claim. Such combinations are proposed herein unless it is stated that a specific combination is not intended. Furthermore, it is intended to include also features of a claim to any other independent claim even if this claim is not directly made dependent to the independent claim.

It is further to be noted that methods disclosed in the specification or in the claims may be implemented by a device having means for performing each of the respective steps of these methods.

Further, it is to be understood that the disclosure of multiple acts or functions disclosed in the specification or claims may not be construed as to be within the specific order. Therefore, the disclosure of multiple steps or functions will not limit these to a particular order unless such steps or functions are not interchangeable for technical reasons. Furthermore, in some embodiments a single step may include or may be broken into multiple sub steps. Such sub steps may be included and part of the disclosure of this single step unless explicitly excluded.

What is claimed is:

1. A sensor device comprising:
a first sensor circuitry configured to provide a first sensor signal in a first frequency band;
a second sensor circuitry configured to provide at least one second sensor signal in a second frequency band; and
a combiner circuitry configured to combine the first and the at least one second sensor signal into a combined sensor signal.

2. The sensor device of claim 1, further comprising an interface to output the combined sensor signal via a single output line.

3. The sensor device of claim 1, wherein the combiner circuitry is configured to provide the combined sensor signal as a binary signal.

4. The sensor device of claim 1, wherein the combiner circuitry comprises a Pulse Density Modulator (PDM) configured to convert an analog or n-ary digital combined sensor signal, n>2, to a binary combined sensor signal.

5. The sensor device of claim 1, wherein the first sensor circuitry is configured to measure a first physical quantity causing signal variations above a frequency threshold, wherein the second sensor circuitry is configured to measure a second physical quantity causing signal variations below the frequency threshold.

6. The sensor device of claim 1, wherein the first sensor circuitry comprises a microphone.

7. The sensor device of claim 6, wherein the microphone is coupled to a Sigma-Delta Analog-to-Digital Converter (SDADC) configured to provide a digital first sensor signal.

8. The sensor device of claim 7, wherein an output of the SDADC is coupled to a digital high-pass filter.

9. The sensor device of claim 1, wherein the second sensor circuitry comprises at least one of a barometric pressure sensor, a temperature sensor, a humidity sensor.

10. The sensor device of claim 1, further comprising a sampling rate conversion circuitry configured to adapt a sampling rate of the second sensor signal to a sampling rate of the first sensor signal, or vice versa.

11. The sensor device of claim 1, further comprising a circuitry configured to shift the first and/or the at least one second sensor signal to first and second non-overlapping frequency bands.

12. The sensor device of claim 1, wherein the first and the second sensor circuitry are arranged within a common semiconductor package.

13. The sensor device of claim 1, wherein the first and the second sensor circuitry are disposed on a common semiconductor die.

14. A method comprising:
providing a first sensor signal in a first frequency band;
providing at least a second sensor signal in a second frequency band; and
combining the first and the at least one second sensor signal into a combined sensor signal.

15. The method of claim 14, further comprising transmitting the combined sensor signal via a single signal line.

16. The method of claim 14, wherein the combined sensor signal is transmitted as a binary signal.

17. The method of claim 14, wherein the first and the second sensor signals are provided in first and second non-overlapping frequency bands.

18. The method of claim 14, wherein the first frequency band comprises frequencies higher than 20 Hz and wherein the second frequency band comprises frequencies lower than 20 Hz.

19. The method of claim 14, wherein the first sensor signal is an acoustic sensor signal and wherein the second sensor signal is a pressure or temperature sensor signal.

20. A receiver device comprising:
a receiver circuitry configured to receive a combined sensor signal comprising a first sensor signal in a first frequency band and at least a second sensor signal in a second frequency band; and
a separation circuitry configured to separate the combined sensor signal into the first and the second sensor signal.
